(19) United States
(12) Patent Application Publication
(10) Pub. No.: US 2026/0311390 A1
(43) Pub. Date: Oct. 8, 2026

(54) Systems and Methods for Automated Video Editing Using Artificial Intelligence Algorithms

(71) Applicant: SmartSceneAI, LLC, Carthage, TN (US)

(72) Inventors: Aden Bruce Bahadori, Toronto (CA); Brett Key Granstaff, Carthage, TN (US)

(21) Appl. No.: 19/098,969

(22) Filed: Apr. 2, 2025

(51) Int. Cl. G06T 11/60; G06V 10/40; G10L 15/26

(52) U.S. Cl. CPC G06T 11/60; G06V 10/40; G10L 15/26

(57) ABSTRACT

Systems and methods are disclosed herein for automated video editing using artificial intelligence (AI) algorithms. The systems and methods can use machine learning, computational creativity, media metadata processing, and audio-visual data synthesis to produce creatively-driven edits. AI algorithms can interpret video data, audio data, and metadata of uploaded video and audio files to generate unique and contextually appropriate edit sequences. A computing device with AI algorithms can access the metadata associated with the video and audio files, identify features in the video frames and audio tracks, generate an initial edit of the video frames and the audio tracks based on the metadata and features, apply user preferences to the initial edit to generate a final edit, and render and export the final edit. An adaptive learning system can improve the decision-making processes of the AI algorithms over time based on user preferences applied to the edits and current editing trends.

### TECHNICAL FIELD

The present disclosure generally relates to video editing, and more particularly to systems and methods for automated video editing using artificial intelligence algorithms.

### BACKGROUND

The present disclosure generally relates to video editing systems. In the field of video editing, creating professional level content often requires significant time, effort, and creative expertise. Traditional video editing workflows rely heavily on manual processes, where editors must sift through large volumes of video footage and audio to craft compelling narratives. However, this approach is labor-intensive, subjective, and can be limited by human capacity to efficiently analyze all available data.

While some artificial intelligence (AI) systems exist to assist with tasks such as speech-to-text transcription, object recognition, or basic scene categorization, these systems focus on isolated functionalities, rather than holistic and creative editorial workflows. Moreover, these AI systems fail to integrate metadata, such as timecode annotations, scene descriptions, or user preferences, in a meaningful way to enhance creative decision-making in the video editing process.

As a result, there is a significant need for a comprehensive AI video editing system that can automate technical tasks and produce creatively-driven edits based on metadata, video data, and audio data. The need for such an AI video editing system is especially pronounced in industries such as film production, digital marketing, and content creation, where high-quality and time-sensitive editing is crucial.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Traditional video editing workflows rely heavily on manual processes, which are labor-intensive, subjective, and limited by human capacity to analyze data, and current artificial intelligence (AI) systems focus on isolated functionalities rather than holistic and creative editorial workflows. What is needed is a comprehensive AI video editing system that can automate technical tasks and produce creatively-driven edits based on metadata, video data, and audio data, for video editing, post-production automation, and creative content generation. The present disclosure generally relates to video editing, and more particularly to systems and methods for automated video editing using AI algorithms. The systems and methods of the present disclosure encompass machine learning, computational creativity, media metadata processing, and audio-visual data synthesis. In particular, AI algorithms can interpret video data, audio data, and metadata to generate unique and contextually appropriate edit sequences, such as by analyzing and synthesizing the video data, audio data, and metadata. The AI algorithms can automate the generation of the unique and contextually appropriate edit sequences. Additionally, a framework of AI algorithms directed to the video editorial process can be designed to simulate human creative decision-making while enhancing the speed and efficiency of the editing process. Such an approach to video editing combines the precision of automated processing with the creative decision-making required for professional video production, thereby transforming post-production workflows by bridging the gap between automation and creativity in video editing and significantly enhancing efficiency, consistency, scalability, accessibility, and artistic quality in the resulting video. As a result, the time required to analyze and edit large volumes of video and audio footage is reduced, the creative potential of editors is increased by the intelligent suggestions and automated routine tasks, any size project, from short clips to feature-length productions, can be produced at a professional level by users of various skill, and the consistency of edits is maintained at a high quality with minimal human intervention which reduces errors and inconsistencies.

One aspect of the disclosure is a method. The method may include a method for video editing with artificial intelligence algorithms. The method may include accessing, by a computing device comprising artificial intelligence algorithms, metadata associated with one or more media files. The method may include identifying, by the computing device, features in video frames associated with the one or more media files. The method may include identifying, by the computing device, features in audio tracks associated with the one or more media files. The method may include automatically generating, by the computing device, an initial edit of the video frames and the audio tracks based on the metadata, the features in the video frames, and the features in the audio tracks. The method may include applying user preferences to the initial edit to generate a final edit.

Another aspect of the disclosure is a system having at least one memory storing non-transitory computer-executable instructions and at least one artificial intelligence algorithm, and at least one processor. The non-transitory computer-executable instructions, when executed by the at least one processor, can cause the at least one processor to perform operations. The operations may include accessing metadata associated with one or more media files. The operations may include identifying, via the at least one artificial intelligence algorithm, features in video frames associated with the one or more media files. The operations may include identifying, via the at least one artificial intelligence algorithm, features in audio tracks associated with the one or more media files. The operations may include automatically generating, via the at least one artificial intelligence algorithm, an initial edit of the video frames and the audio tracks based on the metadata, the features in the video frames, and the features in the audio tracks. The operations may include applying user preferences to the initial edit to generate a final edit.

Another aspect of the disclosure is a non-transitory computer-readable storage medium having executable instructions stored thereon. The executable instructions, when executed by a processor, may be configured to perform one or more operations. The one or more operations may include accessing metadata associated with one or more media files. The one or more operations may include identifying features in video frames associated with the one or more media files. The one or more operations may include identifying features in audio tracks associated with the one or more media files. The one or more operations may include automatically generating an initial edit of the video frames and the audio tracks based on the metadata, the features in the video frames, and the features in the audio tracks. The one or more operations may include applying user preferences to the initial edit to generate a final edit.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a block diagram illustrating an example embodiment of a system of the present disclosure.

FIG. 2 is a sequence block diagram illustrating an example embodiment of a system of the present disclosure.

FIG. 3 is a sequence diagram illustrating an example embodiment of a system of the present disclosure

FIG. 4 is a flowchart diagram illustrating an example embodiment of a method of the present disclosure.

### DETAILED DESCRIPTION

Reference will now be made in detail to exemplary embodiments of the disclosure, some aspects of which are illustrated in the accompanying drawings.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

The present disclosure is directed to systems and methods for automated video editing using artificial intelligence (AI) algorithms. The AI-driven video editing systems and methods are designed to automatically generate unique and creative edit sequences by leveraging metadata, video data, and audio data. The advanced AI algorithms of the system can analyze and interpret source material, including video footage and audio tracks, alongside contextual metadata, such as timestamps, scene descriptions, and user preferences. Editorial creative algorithms can process this data to determine optimal cuts, transitions, effects, and narrative flow, to produce highly customized and contextually relevant video edits. The system can support real-time previews, adaptive learning based on user feedback, and seamless integration with industry-standard editing software, to enable filmmakers, content creators, and editors to achieve professional-grade results with enhanced efficiency and creative flexibility.

AI algorithms can interpret video data, audio data, and metadata to generate unique and contextually appropriate edit sequences, such as by analyzing and synthesizing the video data, audio data, and metadata. The AI algorithms can automate the generation of the unique and contextually appropriate edit sequences. Additionally, a framework of AI algorithms directed to the video editorial process can be designed to simulate human creative decision-making while enhancing the speed and efficiency of the editing process. For instance, a metadata integration module can collect and process metadata that is associated with video files and audio files (e.g., timestamps, scene descriptions, camera settings, user-defined markers, and contextual annotations) to serve as a guide to understand the structure and intent of the media. AI video and audio analysis engines can use machine learning algorithms to interpret visual and auditory content of the video files and the audio files, respectively, such as identifying objects, characters, scenes, emotions, and key events in the media, processing audio tracks for dialogue, music, and sound effects, and classifying each audio track's role in the narrative. A creative editorial algorithm suite can include algorithms that apply editorial logic to the analyzed data and can be designed to mimic the creative intuition of human editors by considering pacing, transitions, narrative structure, and user preferences to generate dynamic edits that balance technical precision with artistic intent. A user customization interface can allow editors to specify preferences, such as mood, style, pacing, and output format, which can be used as inputs to refine the decision-making process of the AI system. An adaptive learning system can incorporate adaptive learning capabilities to improve the system over time based on user feedback and trends in editing styles, thereby ensuring that the AI system remains relevant to evolving creative demands. Integration and export tools can allow the AI system to be integrated within editing software to allow editors to further refine the AI-generated edits, and support many output formats for different platforms from social media to theatrical releases.

The video data, audio data, and metadata can be imported into the AI system. The metadata integration module can organize and categorize the data that was imported into the AI system, and the AI video and audio analysis engines can process the data to extract insights. The creative editorial algorithm suite can synthesize these insights to automatically generate an initial edit. Users can then review, customize, and finalize the initial edit through the user customization interface. The adaptive learning system can record the user inputs from the user to enhance future performance of the AI system by training the AI system (e.g., the metadata integration module, AI video and audio analysis engines, and creative editorial algorithm suite) with the user inputs to learn the user's preferences for initial edits. For instance, the adaptive learning system may automatically update or refine how metadata is integrated by learning from new sources or patterns in the data; however, frequent retraining may not be needed in implementations where the metadata integration relies on predefined structures.

Applications of the systems and methods of the present disclosure include accelerated editing of raw footage and preservation of creative integrity in film and television production (e.g., trailers, documentaries, full-length features), quick and easy production of professional-level videos for content creation for digital platforms, streamlined post-production workflows for repetitive tasks to allow for creative focus, automated editing of live event footage in real-time or post-event for timely delivery, and education and training for training videos, e-learning materials, and teaching editing techniques through AI-assisted insights. The AI approach of the present disclosure in video editing enhances efficiency, consistency, scalability, accessibility, and artistic quality in video edits, thereby overcoming deficiencies in current video editing workflows that rely on limited labor-intensive manual processes.

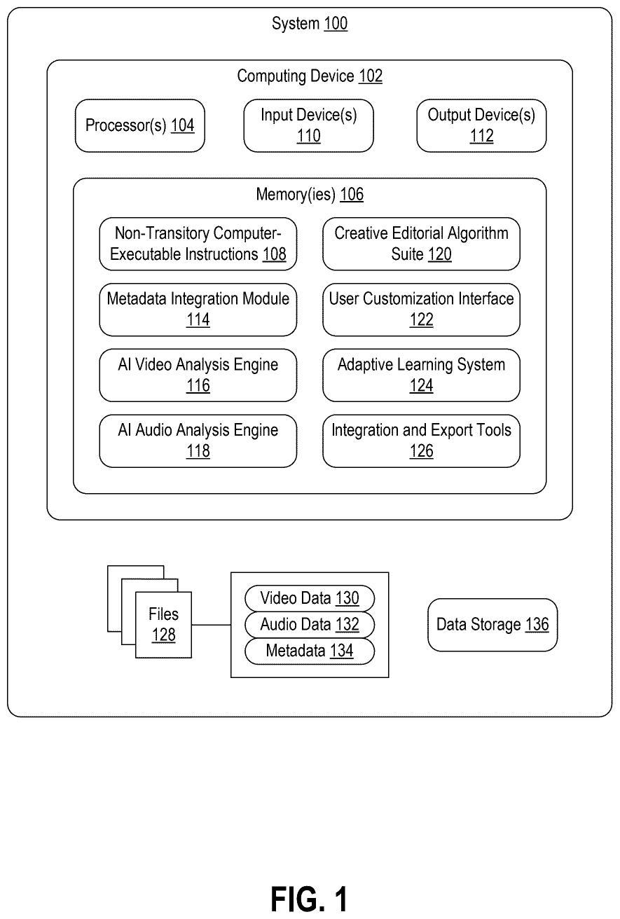

FIG. 1 is a block diagram illustrating an example embodiment of a system 100 of the present disclosure. The system 100 can include a computing device 102 with at least one processor 104 and one or more memories 106. The memories 106 can store non-transitory computer-executable instructions 108. The computing device 102 can also comprise one or more input devices 110 and one or more output devices 112. The non-transitory computer-executable instructions 108, upon execution, can cause the computing device 102 to perform the methods for automated video editing using AI algorithms.

The system 100 may include a metadata integration module 114, an AI video analysis engine 116, an AI audio analysis engine 118, a creative editorial algorithm suite 120, a user customization interface 122, an adaptive learning system 124, and integration and export tools 126. In some implementations, the memories 106 may include one or more of the AI video analysis engine 116, the AI audio analysis engine 118, the creative editorial algorithm suite 120, the user customization interface 122, the adaptive learning system 124, or the integration and export tools 126. The system 100 can also include video and audio files 128 (e.g., from an input device 110, such as a video camera, external hard drive or data storage, or other computing device, as non-limiting examples), which each include video data 130, audio data 132, and metadata 134 associated with the respective file. A data storage 136 (e.g., a database or cloud storage) can also be included in the system 100, which may store the files 128.

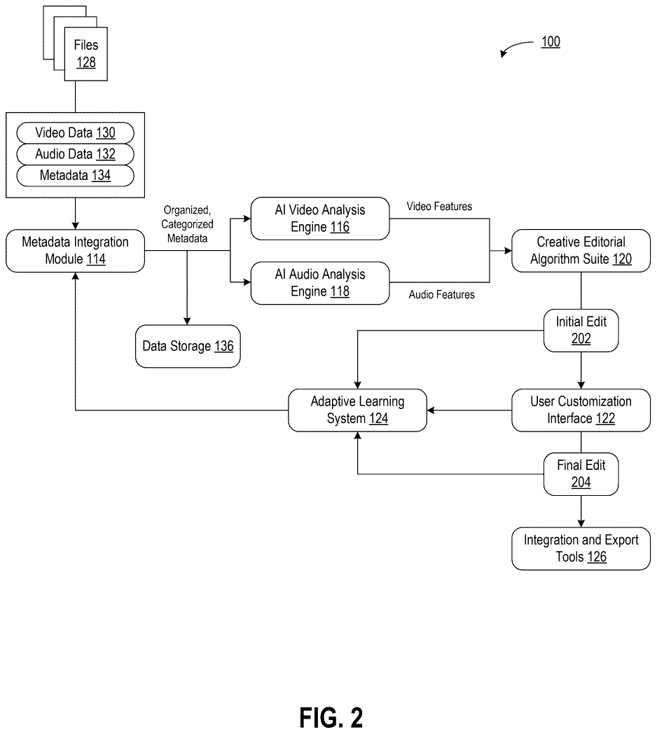

FIG. 2 is a sequence block diagram illustrating an example embodiment of the system 100 of the present disclosure. In the example of FIG. 2, data may be input into the system 100, such as by a user uploading the media files 128 (i.e., the video files and audio files), and the metadata integration module 114 can automatically detect and import the metadata 134 embedded in the files 128. The metadata integration module 114 can collect and process the metadata 134 that is associated with video files and audio files 128 to serve as a guide to understand the structure and intent of the media embedded in the files 128. For example, the metadata 134 may include timestamps, camera angles, shot descriptions, scene descriptions, lens settings, camera settings, geo-tags, user-defined markers, contextual annotations, and/or production notes, as non-limiting examples. The metadata integration module 114 may receive or access the metadata 134, as well as the video data 130 and/or the audio data 132, from one or more of the files 128. For example, the files 128 may be stored in the data storage 136 and the metadata integration module 114 may query the data storage 136 to obtain and access the files 128 and then extract its data (video data 130, audio data 132, and metadata 134). The metadata integration module 114 can organize, categorize, and contextualize the metadata 134 to provide a structured understanding of the content, such as in a data table. The metadata integration module 114 acts as the foundation for aligning the decisions of the AI algorithms with a user's intent to ensure that edits are contextually appropriate.

In one example, the metadata integration module 114 may organize, categorize, and contextualize the metadata 134 to provide a structured understanding of the content by including continuity, camera, sound, script, and other reports through a structured and automated system. To perform such a process, the metadata integration module 114 may receive the metadata 134 from one or more sources, such as script notes, timecoded sound reports, and camera metadata files, as non-limiting examples, and normalize the formats of the metadata 134 to produce consistency in the metadata 134, such by matching timecode formats or coordinating file naming conventions, as non-limiting examples. To categorize and organize the metadata 134 for scene-based structuring, the metadata integration module 114 may link the metadata 134 to individual scenes, takes, and/or shots (e.g., from the video data 130) to create a relational database (e.g., in the data storage 136). For instance, each entry of metadata 134 in the relational database may be categorized by its origin (i.e., its departmental origin), such as camera reports (e.g., lens, FPS, ISO, white balance, clip names), sound reports (e.g., track assignments, microphone type and placement, wild takes), continuity notes (e.g., shot descriptions, wardrobe tracking, prop tracking), script supervisor notes (e.g., line changes, circled takes, performance notes), or miscellaneous reports (e.g., VFX requirements, production design), and cross-referenced to link the related metadata 134 (e.g., matching a camera take ID to a corresponding sound file and script notes). The metadata integration module 114 may contextualize the data (video data 130, audio data 132, and/or metadata 134) to allow users to easily search for the data, such by timestamp through time-aligning the data, by tags through AI-assisted automatic tagging of scene elements (e.g., characters, props, locations), and/or by updates through tracking updates in the revision history (e.g., new takes, director notes).

Together, the AI video analysis engine 116 and the AI audio analysis engine 118 can process and analyze the uploaded media to identify visual and auditory patterns, narrative cues, and structural elements.

The AI video analysis engine 116 can include AI algorithms that use computer vision and machine learning techniques to analyze video frames for features such as objects, characters, settings, lighting conditions, colors, visual styles, and motion patterns, as non-limiting examples, from the video files 128. For instance, analyzing the video frames for features may include AI algorithms performing scene segmentation and shot classification, object and character recognition, emotion and sentiment analysis, action recognition, style and cinematography analysis, and/or automated subtitling and dubbing.

The video frames can be extracted from the video data 130 associated with the video files 128, such as by the metadata integration module 114 or the AI video analysis engine 116. The AI video analysis engine 116 may identify and categorize different types of shots (e.g., close-ups, wide shots, over-the-shoulder shots) and detect scenes in the video frames. Scenes may be detected in the video frames by the AI video analysis engine 116 identifying logical scene boundaries through a combination of action, dialogue, and script notes that signal shifts in time, location, character dynamics, or emotional intensity. For example, the AI video analysis engine 116 may detect scene boundaries by analyzing the screenplay structure (which may be received as an input, e.g., via the files 128) to identify elements that signal scene transitions, such as scene headings, action descriptions (e.g., a new setting, key character entrance, or sudden event), dialogue shifts, and script notes and beats (e.g., pauses, parentheticals, or visual cues to indicate shifts in pacing). The AI video analysis engine 116 may further highlight pivotal moments in the video frames and suggest potential focal points by analyzing the screenplay structure and video to evaluate how a scene builds tension, resolves conflict, or introduces new stakes. For example, the AI video analysis engine 116 may track emotional and narrative arcs in the script, such as scenes with heightened conflict or resolutions (e.g., a character's revelation or decision) or a major plot twist or character transformation, analyze actions and stakes, such as scenes with high-stakes choices, action sequences, or major confrontations, identify turning points, such as where a character's goal is achieved, altered, or blocked, and detect payoffs and setups based on foreshadowed elements in the script coming to fruition later, repeated motifs, or callbacks that redefine earlier scenes. Based on this analysis, the AI video analysis engine 116 may combine the script structure with these narrative markers to suggest focal points that drive engagement and highlight key storytelling moments.

The AI video analysis engine 116 may perform object and character recognition that identifies actors, props, and background elements using facial and object detection algorithms (which can aid in the continuity analysis and metadata tagging above), recognizes specific actions from actors (e.g., running, fighting, hugging) based on pose estimation and motion tracking, identifies a director's stylistic choices based on color grading, framing, and camera movement, and uses speech-to-text and lip syncing models to generate subtitles and dubbing to improve accessibility and localization of films.

The AI video analysis engine 116 may recognize emotions in the video frames by using facial recognition algorithms and scene context (e.g., facial expressions, voice modulation, and body language) to understand character development, extract emotional tones, and shape the narrative flow. Computer vision and machine learning models trained in facial expression analysis, body language recognition, and contextual scene understanding, may be employed in the AI video analysis engine 116 to extract the emotional tones in the video frames. For example, facial expression analysis may be performed by detecting facial landmarks (e.g., eyebrows, eyes, mouth, nose), classifying emotions into categories based on facial features (e.g., happiness, sadness, anger, surprise, fear, disgust, and neutrality) with classification models, and analyzing muscle movements and mapping the muscle movements to emotions. The body language recognition may be performed by detecting body points (e.g., shoulders, arms, legs, posture) to estimate pose, analyzing the pose to identify emotions, such as a slouched posture indicating sadness, raised arms suggesting excitement, or crossed arms signaling defensiveness, or identifying gestures based on the pose that reflect mood, such as hand gestures, arm movements, or walking patterns. The contextual scene understanding may include using natural language processing (NLP) techniques to analyze text-based context from subtitles or dialogue, scene recognition and object detection to identify reactions, such as tears, smiles, or celebratory gestures, and environmental queues, such as dim lighting which may suggest a somber mood. The AI video analysis engine 116 may integrate the detected facial, body language, and contextual cues, such as with deep neural networks or transformer-based models, and track emotional changes over time, such as with probabilistic models for increased accuracy over time. The AI algorithms may then extract the patterns it detected from its facial expression analysis, body language recognition, and contextual scene understanding and map the patterns to emotion categories.

The AI audio analysis engine 118 can include AI algorithms that process audio tracks for speech, music, ambient sounds, and sound effects, as non-limiting examples. The audio tracks can be extracted from the audio data 132 associated with the audio files 128, such as by the metadata integration module 114 or the AI audio analysis engine 118. The AI algorithms of the AI audio analysis engine 118 can perform speech-to-text conversion that converts dialog from the audio tracks into text to aid in scene categorization and subtitle generation. The AI audio analysis engine 118 can also perform a mood analysis that analyzes tone, rhythm, and dynamics in music and dialog in the audio tracks, which can enhance synchronization with visual elements in the video as synchronized by the AI algorithms. For example, scene descriptions in the script can be analyzed by the AI algorithms and paired with action, dialogue, and emotional cues in video descriptions extracted by the AI algorithms to determine a mood, which can be set based on a genre. In some implementations, the genre may be determined based on the metadata 134. In some embodiments, the AI video analysis engine 116 and the AI audio analysis engine 118 may include large language models (LLMs).

A context-specific video edit can then be generated by synthesizing the analyzed data (e.g., the analyzed metadata 134, video data 130, and audio data 132) and user preferences to create an initial edit sequence with transitions, effects, and timing adjustments that forms a cohesive and contextually relevant narrative. The creative editorial algorithm suite 120 can include AI algorithms for simulating human editorial decision-making to generate the context-specific initial edit.

The creative editorial algorithm suite 120 can determine the optimal scene transitions, timing, and sequencing of the video frames based on the metadata 134, video data 130, and audio data 132 analyzed by the metadata integration module 114, AI video analysis engine 116, and AI audio analysis engine 118, respectively, to automatically generate an initial edit 202. Determining the optimal scene transitions, timing, and sequencing of the video frames based on the analyzed metadata 134, video data 130, and audio data 132 may include analyzing genre and script pacing using the creative editorial algorithm suite 120. For instance, genre and pacing considerations may include fast cuts, quick transitions, and short scene durations (e.g., 1-2 minutes) for an action/thriller to keep the tension and excitement, longer scene durations (e.g., 3-5 minutes) with gradual pacing for a drama to show character development and emotional depth, cuts based on timing to punchlines and comedic beats in comedies to keep the momentum of the comedy, pacing for long, suspenseful build ups followed by sudden cuts or quick, disorienting transitions for horror, or smooth pacing with well-placed transitions (e.g., dissolves, match cuts) for documentaries to keep the story engaging while maintaining realism. Determining the optimal scene transitions, timing, and sequencing of the video frames based on the analyzed metadata 134, video data 130, and audio data 132 may include scene timing and transitions, such as applying cuts on “action” or “cut” to keep the momentum and ensure seamless flow, match cuts to connect scenes visually or thematically for fluid storytelling, L-cuts or J-cuts to allow dialogue or sound to lead into the next scene for smoother transitions by detecting when a character's dialogue or ambient sound should overlap into the next scene for smoother transitions, hard cuts or jump cuts for abrupt tonal shifts, urgency, or stylistic purposes, or fades or dissolves for time jumps, softer transitions, or emotional beats.

The creative editorial algorithm suite 120 may further analyze the script metadata (in the metadata 134) for scene descriptions, dialogue pacing, or action beats to suggest an appropriate scene duration based on the genre. For example, a chase scene may be detected based on the analysis of the script metadata and the AI algorithms may recommend faster cuts for intensity, or character-driven moments may be identified in a drama and the AI algorithms may recommend longer, emotionally resonant takes in the edit. The generated suggestions of appropriate scene duration based on the genre may include adaptive scene timing where the AI algorithms automatically suggest trim points based on pacing models from similar films in the genre.

In some embodiments, determining the optimal scene transitions, timing, and sequencing of the video frames based on the analyzed metadata 134, video data 130, and audio data 132 may include transitions and scene flow generated using machine learning models trained on professional films to determine a suitable transition type to apply to an edit based on scene context and suggest or automatically apply particular transitions for the scene context. The creative editorial algorithm suite 120 may further provide dynamic scene sequencing and shot prioritization by analyzing the narrative arc (e.g., via the script metadata or analyzed video frames) to determine whether a sequence flows correctly, such as by determining that a subplot is slowing the pace and recommending a scene reorder for a stronger emotional payoff in response, prioritizing reaction shots based on facial recognition and emotional intensity to ensure pivotal moments receive proper screen time, or suggesting a stronger sequence for maintaining audience engagement.

Additionally, the creative editorial algorithm suite 120 can apply stylistic choices, such as fast cuts for action scenes or slow fades for emotional sequences to the initial edit 202 based on user-defined parameters. In some embodiments, the creative editorial algorithm suite 120 can provide automated suggestions for enhancing narrative flow and visual coherence in the initial edit 202.

The user customization interface 122 can include an interactive graphical user interface for users to input preferences, such as style, mood, target audience, pacing, narrative flow, and output format, as non-limiting examples. The user customization interface 122 can display a preview of the AI-generated edits (i.e., the initial edit 202) for user review and adjustment of the edits to obtain real-time feedback. For instance, the initial edit 202 can be transmitted to a display device (e.g., the output device 112) with a graphical user interface to display the initial edit 202. The user customization interface 122 can also include presets and templates, such as pre-designed styles (e.g., cinematic, documentary, social media-friendly) to streamline editorial workflows. A user may adjust the initial edit 202 or apply the presets or templates to the initial edit 202, which can be used by the system 100 to generate a final edit 204.

The adaptive learning system 124 can include a learning process that records user inputs, preferences, and feedback to continuously refine and improve the decision-making processes of the AI algorithms of the system 100 (e.g., the metadata integration module 114, the AI video analysis engine 116, the AI audio analysis engine 118, and the creative editorial algorithm suite 120).

The adaptive learning system 124 may adapt over time via a continuous feedback loop that can refine the accuracy of the AI algorithms of the system 100 over time using automated scene analysis, rating and scoring mechanisms, adaptive learning via feedback, module-level adjustments, and/or pattern recognition and refinement. Automated scene analysis performed by the adaptive learning system 124 may include comparing the initial edit 202 with the original script using NLP and scene recognition to ensure that the dialogue and actions in the initial edit 202 and the script match. The adaptive learning system 124 may use a rating and scoring mechanism that assigns a score to the initial edit 202 based on how much the initial edit 202 aligns with the script, such as a number or percentage of similarity or dissimilarity, and any discrepancies that are detected (e.g., missing lines, altered sequences) may be flagged for review.

The adaptive learning system 124 can also adapt to individual user style and project requirements over time to generate personalized outputs in the final edits. For instance, the adaptive learning system 124 can record the user review and adjustments made to the initial edit 202 and the changes between the initial edit 202 and the final edit 204. A user can override some of the flags or adjust the rating to allow the adaptive learning system 124 and the AI algorithms of the system 100 to learn to recognize acceptable creative derivations from the script, such as a small change in dialogue in the final edit 204 that retains the original meaning from the script, by feeding such overrides back into the AI algorithms of the system 100 to improve future accuracy of the AI algorithms. The module-level adjustments may include having separate AI modules for dialogue verification, scene continuity, action detection, and other features, where each module can adapt independently by adjusting weighting factors based on prior user inputs and confirmed edits in the final edit 204. The adaptive learning system 124 may recognize editing patterns for particular genres, styles, or editors over time by analyzing multiple projects in a genre, style, or edited by a particular editor and refine the rating system based on such analysis to improve future edits in such a genre, style, or edited by a particular editor. The rating system can therefore adjust dynamically over time to improve future edits by learning from editorial decisions, user feedback, and pattern recognition to generate increasingly accurate and context-aware ratings for assigning a score to an edit.

The final edit 204 can be rendered and exported in a desired format, ready for distribution or further refinement in additional software. The integration and export module 126 can support integrations of the system 100 with video editing software for advanced and efficient post-editing. The integration and export module 126 can also support multiple formats and export the final edit 204 in a variety of formats that are optimized for different types of platforms and productions (e.g., theatrical releases, social media). In some implementations, the integration and export module 126 can render and export multiple versions of the final edit 204, such as a version formatted for social media, a version formatted for film production, and a version formatted for advertising.

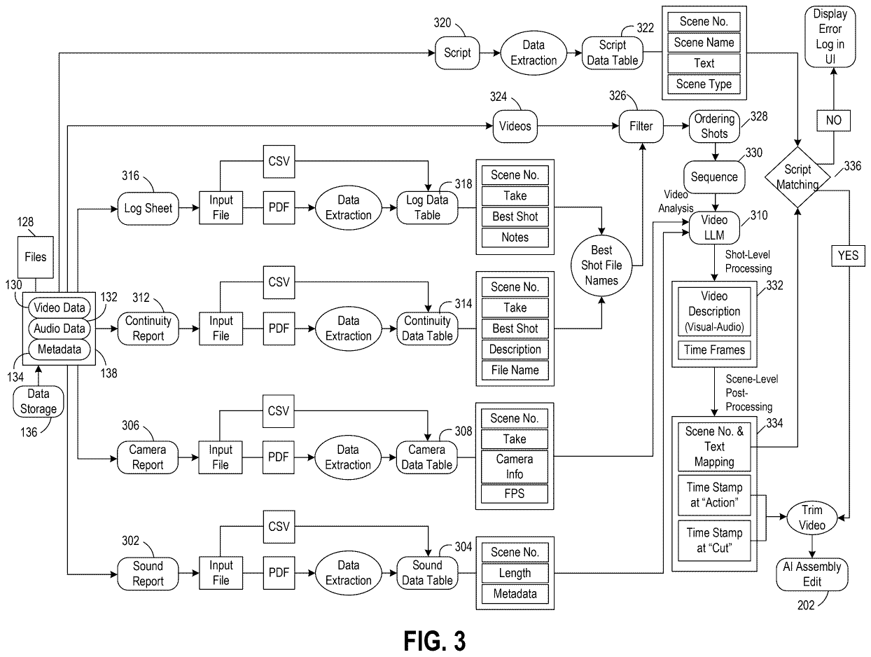

FIG. 3 is a sequence diagram illustrating an example embodiment of the system 100 of the present disclosure. In the example of FIG. 3, data 138 may be obtained from a database and/or data storage 136, such as video files, audio files, and metadata (e.g., video data 130, audio data 132, and metadata 134, respectively). The data 138 may include a sound report 302 (e.g., a PDF or CSV file from among files 128) that can be input into the system 100 (e.g., the AI video analysis engine 116, AI audio analysis engine 118, and/or the creative editorial algorithm suite 120) and its data can be extracted to build a sound data table 304, which may include the scene number, length, and metadata, as non-limiting examples. The data 138 may include a camera report 306 (e.g., a PDF or CSV file from among files 128) that can be input into the system 100 (e.g., the AI video analysis engine 116, AI audio analysis engine 118, and/or the creative editorial algorithm suite 120) and its data can be extracted to build a camera data table 308, which may include the scene number, take, camera information, and frame rate (FPS), as non-limiting examples. The sound data table 304 and the camera data table 308 may be input into a video machine learning model 310 (e.g., an LLM). The data 138 may include a continuity report 312 (e.g., a PDF or CSV file from among files 128) that can be input into the system 100 (e.g., the AI video analysis engine 116, AI audio analysis engine 118, and/or the creative editorial algorithm suite 120) and its data can be extracted to build a continuity data table 314, which may include the scene number, take, best shot, description, and file name, as non-limiting examples. The data 138 may include a log sheet 316 (e.g., a PDF or CSV file from among files 128) that can be input into the system 100 (e.g., the AI video analysis engine 116, AI audio analysis engine 118, and/or the creative editorial algorithm suite 120) and its data can be extracted to build a log data table 318, which may include the scene number, take, best shot, and notes, as non-limiting examples. The data 138 may include a script 320 (e.g., a PDF or CSV file from among files 128) that can be input into the system 100 (e.g., the AI video analysis engine 116, AI audio analysis engine 118, and/or the creative editorial algorithm suite) and its data can be extracted to build a script data table 322, which may include the scene number, scene name, text, and scene type, as non-limiting examples.

The data 138 may also include videos 324 that can be input into a filter 326 that also receives the best shot file names from the continuity data table 314 and the log data table 318. The best shots identified in the continuity data table 314 and the log data table 318 may be determined based on labels in the metadata that indicated that these were the best shots. The filter 326 can output an ordering of shots 328 and the video analysis by AI algorithms (e.g., the creative editorial algorithm suite 120) can include determining a standard sequence 330, which can be input into the video machine learning model 310 (e.g., an LLM). To output the ordering of shots 328, the filter 326 may include a set of rules that correspond to a set of standard editing choices and principles for choosing shots and shot order. Examples of standard editing choices and principles for choosing shots and shot order which may be the basis for the rules include maintaining continuity (e.g., matching on action to ensure action flows smoothly between cuts, such as a character opening a door in one shot should be in the same position in the next shot, eyeline matching to ensure that a character looking off-screen matches the perspective of the next shot, applying the 180-degree rule of keeping the camera on one side of an imaginary line to maintain consistent spatial relationships, applying the 30-degree rule to change the camera angle by at least 30 degrees between cuts to avoid a jump cut), prioritizing emotional impact (e.g., using close-ups for intimacy and emotional weight, wide shots to establish setting an context, or reaction shots to emphasize emotional responses), controlling pacing and rhythm (e.g., applying faster cuts to create urgency and tension or longer takes to allow moments to breathe, aligning shots with the emotional tone of a scene, such as fast cuts in a chase scene or slow lingering shots in a romantic moment), guiding the viewer's focus (e.g., cutting to what the audience should pay attention to, using movement, light, or framing to direct the eye before cutting, avoiding unnecessary cuts that disrupt immersion), maintaining spatial and temporal clarity (e.g., establishing geography with wide shots before moving into close-ups, keeping transitions between shots logical so that time and space feel continuous in edits that are not montages or purposeful jump cuts), and using cuts for storytelling over style (e.g., ensuring each cut serves a purpose, such as revealing information, building suspense, or advancing the narrative, over stylistic cuts that can be distracting when out of place, such as quick zooms, crash zooms, or whip pans). The AI algorithms (e.g., the creative editorial algorithm suite 120) may apply this set of rules to the shots identified in the continuity data table 314 and the log data table 318 and may additionally apply creative choices beyond the rules. This video analysis can produce a standard sequence 330 or multiple editing options in the form of multiple sequences 330 with different editing choices to provide different options for a scene for a user to choose from. In some embodiments, the video analysis can be performed in a parallel processing pipeline.

The video machine learning model 310 may receive the sound data table 304, the camera data table 308, and the sequence 330, perform shot-level processing 332 to generate a video description and time frames, and perform scene-level post-processing 334 to generate scene numbers and text mapping, time stamps at the “action” keyword, and time stamps at the “cut” keyword.

Script matching 336 can be performed by inputting the script data table 322 and the scene number and text mapping into the system 100 (e.g., the AI video analysis engine 116, AI audio analysis engine 118, and/or the creative editorial algorithm suite 120) to determine whether there is a match between the scenes from the video analysis and the text in the script. For example, an audio transcript from the videos can be generated based on the data 138 and the audio transcript can be matched to the script to pair the timecodes of the audio transcript with the script to make an editing decision. If there is no script matching, then an error log or other notification can be generated and displayed in a graphical user interface. If there is script matching, then the system 100 (e.g., the AI video analysis engine 116, AI audio analysis engine 118, and/or the creative editorial algorithm suite 120) can trim the video generated by the above video analysis based on the time stamp at the “action” keyword and the time stamp at the “cut” keyword to generate an AI-assembled video edit (e.g., initial edit 202).

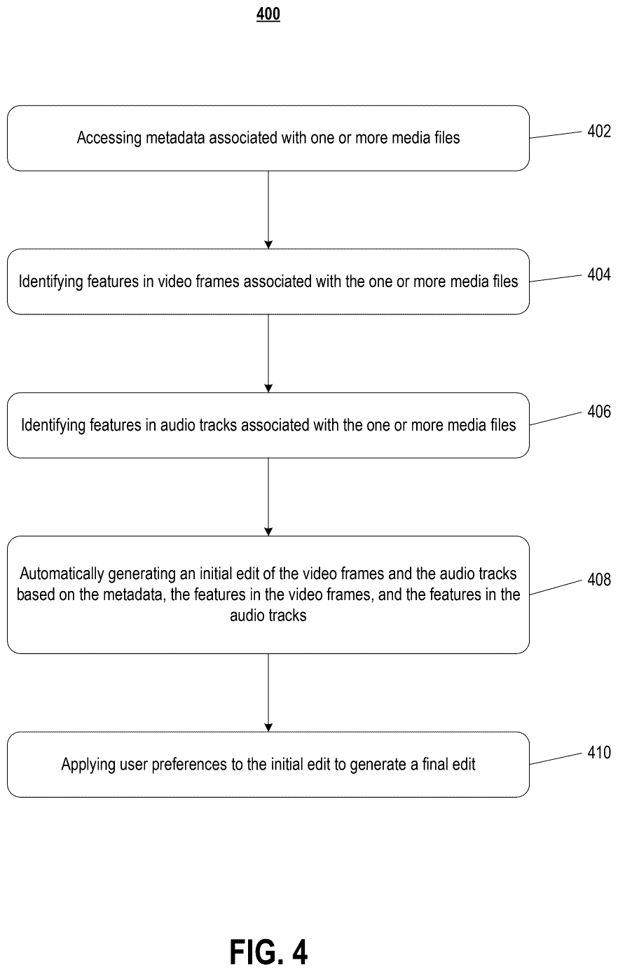

FIG. 4 is a flowchart diagram illustrating an example embodiment of a method 400 of the present disclosure. In certain embodiments, the method 400 for video editing with artificial intelligence algorithms may include the step of providing one or more memories 106. The memories 106 may store non-transitory computer-executable instructions 108 for video editing with artificial intelligence algorithms.

The method 400 may include operation 402 of accessing metadata associated with one or more media files. The media files may comprise one or more of video files or audio files. The metadata may comprise one or more of timestamps, camera angles, shot descriptions, scene descriptions, lens settings, camera settings, geo-tags, user-defined markers, contextual annotations, or production notes associated with the one or more media files.

The method 400 may include operation 404 of identifying features in video frames associated with the one or more media files. The features in the video frames may comprise one or more of objects, characters, settings, lighting conditions, colors, visual styles, or motion patterns. In some implementations, identifying the features in the video frames associated with the one or more media files may comprise extracting the video frames from video data associated with the one or more media files, identifying scene boundaries in the video frames, generating suggestions for focal points in the video frames, and extracting emotional tones from the video frames based on facial recognition and scene context.

The method 400 may include operation 406 of identifying features in audio tracks associated with the one or more media files. The features in the audio tracks may include one or more of speech, music, ambient sounds, or sound effects. In some implementations, identifying the features in the audio tracks associated with the one or more media files may comprise extracting the audio tracks from audio data associated with the one or more media files, identifying dialog in the audio tracks, converting the dialog to text, categorizing a scene based on the text, and generating subtitles based on the text. In some implementations, identifying the features in the audio tracks associated with the one or more media files may comprise extracting the audio tracks from audio data associated with the one or more media files, identifying music in the audio tracks, detecting one or more of tone, rhythm, or dynamics in the music, and synchronizing the music with the video frames based on the one or more of tone, rhythm, or dynamics in the music.

The method 400 may include operation 408 of automatically generating an initial edit of the video frames and the audio tracks based on the metadata, the features in the video frames, and the features in the audio tracks. The initial edit may comprise scene transitions, timing, and sequencing of the video frames based on the metadata, the video frames, and the audio tracks, and stylistic choices based on user-defined parameters.

The method 400 may include operation 410 of applying user preferences to the initial edit to generate a final edit. The user preferences may comprise templates for pre-designed editorial styles.

In some implementations, the method 400 may further include the operation of extracting the metadata from the one or more media files, categorizing the metadata, and organizing the categorized metadata in a data table. In some implementations, the method 400 may further include the operation of transmitting the initial edit to a graphical user interface for display prior to applying the user preferences to the initial edit. In some implementations, the method 400 may further include the operations of recording the user preferences applied to the initial edit and training the artificial intelligence algorithms based on the final edit. In some implementations, the method 400 may further include the operations of converting the final edit to a format based on a platform or production type for the final edit and exporting the converted final edit.

The presently disclosed systems and methods have a wide application anywhere in the video editing industry where automatic, efficient video edits are needed. One particularly important application for the systems and methods described herein relates to post-production automation. Additional systems and methods include creative content generation and digital marketing. However, the systems and methods described above could be utilized in other contexts.

As used herein, the term “computing device” may include a processor-controlled device, such as, by way of example, a personal computer, workstation, server, client, mini-computer, mainframe computer, desktop computer, laptop computer, smartphone, tablet, network of one or more individual computers, mobile computer, portable computer, handheld computer, or any combination thereof. The described systems and techniques may be performed by a system that includes a single computing device or more than one computing device.

A computing device may include an integrated circuit (IC) and may include an application-specific integrated circuit (ASIC) or some other type of IC. A computing device may be a uniprocessor or multiprocessor machine. Accordingly, a computing device may include one or more processors and, thus, the system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), gated logic, and other suitable hardware configured to perform the various functionality described throughout this disclosure. In some embodiments, features of the system can be implemented primarily in hardware using, for example, hardware components such as application-specific integrated circuits (ASICs) or field-programmable gated arrays (FPGAs). Implementation of the hardware circuitry will be apparent to persons skilled in the relevant art(s). In yet another embodiment, features of the system can be implemented using a combination of both general-purpose hardware and software.

The computing device may include one or more memories. Accordingly, the system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data. A basic input/output system (BIOS) can include basic routines that help to transfer information between elements within the system, such as during start-up, can be stored in the one or more memories.

The system can also include one or more storage devices. Examples of a storage device include, but are not limited to, a hard disk drive, a magnetic disk drive, an optical disc drive in combination with an optical medium, a solid-state memory device, or any combination thereof. A storage device can be connected to a bus by an appropriate interface, such as an SCSI, advanced technology attachment (ATA), serial ATA, universal serial bus (USB), IEEE 1394 (FIREWIRE), or any combination thereof. A storage device (or one or more components thereof) can be removably interfaced with the system (e.g., via an external port connector). The storage device and an associated computer-readable medium can provide nonvolatile and/or volatile storage of computer-executable instructions, data structures, program modules, and/or other data for the system.

In particular, the one or more memories may store computer-executable instructions that, when executed by the one or more processors, cause the one or more processors to implement the procedures and techniques described herein. The one or more processors may be operably associated with the one or more memories so that the computer-executable instructions can be provided to the one or more processors for execution. For example, the one or more processors may be operably associated to the one or more memories through one or more buses. Furthermore, the computing device may possess or may be operably associated with input devices (e.g., a keyboard, a keypad, controller, a mouse, a microphone, a touch screen, a sensor) and output devices such as (e.g., a computer screen, printer, or a speaker).

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the C programming language or similar programming languages. The computer readable program instructions may execute on a supercomputer, a compute cluster, or the like. The computer-executable instructions described herein can be downloaded to respective computing/processor devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

The computing device may execute an appropriate operating system such as LINUX®, UNIX®, MICROSOFT® WINDOWS®, APPLE® MACOS®, IBM® OS/2®, ANDROID, and/or the like. The computing device may advantageously be equipped with a network communication device such as a network interface card, a modem, or other network connection device suitable for connecting to one or more networks.

A computing device may advantageously contain control logic, or program logic, or other substrate configuration representing data and instructions, which cause the computing device to operate in a specific and predefined manner as, described herein. In particular, the computing device programs, when executed, enable a control processor to perform and/or cause the performance of features or operations of the present disclosure. The control logic may advantageously be implemented as one or more modules. The modules may advantageously be configured to reside on the computing device memory and execute on the one or more processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like. The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells. The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent. In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

It should be understood that manipulations within the computing device are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computing device or computing devices.

It should also be understood that the programs, modules, processes, methods, and the like, described herein are but an exemplary implementation and are not related, or limited, to any particular computing device, apparatus, or computer language. Rather, various types of general-purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated systems with hard-wired logic or programs stored in nonvolatile memory, such as, by way of example, read-only memory (ROM).

The system may include one or more machine learning models, such as neural networks. The machine learning models may include supervised or unsupervised learning algorithms. For example, a neural network may include a deep neural network (DNN) (e.g., a deep auto-encoder neural network (deep ANN) or a convolutional neural network (CNN)) with an input layer, a plurality of hidden layers, and an output layer. Each layer may have one or more nodes where each node in a current layer is connected to every other node in a previous layer and a next layer (i.e., a fully-connected neural network), or not every node in each layer may be connected to every node in the previous and next layers. Each node in the input layer can be assigned a value and output that value to every node in the next layer (e.g., hidden layer). The nodes in the input layer can represent features about a particular environment or setting. Each node in the hidden layers can receive an outputted value from nodes in a previous layer (e.g., input layer) and associate each of the nodes in the previous layer with a weight. Each hidden node can then multiply each of the received values from the nodes in the previous layer with the weight associated with the nodes in the previous layer and output the sum of the products to each node in the next layer. Nodes in the output layer can handle input values received from the nodes in the hidden layer in a similar fashion. The output value of each output node can output information in a predefined format, where the information has some relationship to the corresponding information from the previous layer. Example outputs may include, but are not limited to, classifications, relationships, measurements, instructions, and recommendations. The output nodes can also be used to classify any of a wide variety of objects and other features and otherwise output any of a wide variety of desired information in desired formats.

Once a given network has been structured for a task, the neural network can be trained using a training dataset. A training system may use a training dataset to train the machine learning models to perform various functions based on input data to predict output data. Supervised learning uses a training dataset to teach models to yield the desired output. The training dataset can include inputs and desired outputs, which allow the model to learn over time. The network processes the inputs and compares the resulting outputs against a set of expected or desired outputs. Errors are then propagated back through the system. The training can adjust to change the weights that control the untrained neural network. The training process occur can repeatedly as the network weights are adjusted to refine the output generated by the neural network. The training process can continue until the neural network reaches a statistically desired accuracy associated with a trained neural network. The trained neural network can then be deployed to implement any number of machine learning operations to output a result. Unsupervised learning is a learning method in which the network uses algorithms to analyze and cluster unlabeled data to discover hidden patterns or data groupings. The training dataset includes input data without any associated output data. The untrained neural network can learn groupings within the unlabeled input and determine how individual inputs relate to the overall dataset. Unsupervised training can be used to for three main tasks—clustering, association, and dimensionality. Clustering is a data mining technique that groups unlabeled data based on similarities and differences, association is a rule-based method for finding relationships between variables in a given dataset, and dimensionality reduction is used when a given dataset's number of features (dimensions) is too high. Variations of supervised and unsupervised training may also be employed. Semi-supervised learning is a technique in which the training dataset includes a mix of labeled and unlabeled data of the same distribution. Incremental learning is a variant of supervised learning in which input data is continuously used to train the model further. Incremental learning enables the trained neural network to adapt to the new data without forgetting the knowledge instilled within the network during initial training.

A convolutional neural network (CNN) is a type of DNN having three additional features: local receptive fields, shared weights, and pooling. The input layer and output layer of a CNN function similar to the input and output layers of a DNN. The CNN is distinguished from a DNN in that the hidden layers of the DNN are replaced with one or more convolutional layers, pooling layers, and fully connected layers. The use of localized receptive fields involves having nodes in the convolutional layers to receive inputs from localized regions in the previous layer. The use of shared weights involves having each node in a convolutional layer assigning the same set of weights to the relative positions of a localized region. The input layer of the CNN can include data representing an image. The image can be passed through a convolutional hidden layer, an optional non-linear activation layer, a pooling hidden layer, and/or a fully connected hidden layers to get an output at the output layer. The convolutional hidden layer analyzes the image data of the input layer. Each node of the convolutional hidden layer is connected to a region of nodes (pixels) of the input image called a receptive field. The convolutional hidden layer can be considered as one or more filters (each filter corresponding to a different activation or feature map), with each convolutional iteration of a filter being a node or neuron of the convolutional hidden layer. The mapping from the input layer to the convolutional hidden layer is referred to as an activation map or feature map. The activation map includes a value for each node representing the filter results at each location of the input volume. The activation map can include an array containing the various total sum values resulting from each iteration of the filter on the input volume. The convolutional hidden layer can include several activation maps to identify multiple features in an image. A pooling hidden layer can be applied after the convolutional hidden layer and is used to simplify the information in the output from the convolutional hidden layer. The pooling hidden layer can take each activation map output from the convolutional hidden layer and generate a condensed activation map using a pooling function. The pooling function can be applied to each activation map in the convolutional hidden layer. The final layer of connections in the network is a fully connected layer that connects every node from the pooling hidden layer to every one of the output nodes in the output layer. The fully connected layer can obtain the output of the previous pooling layer, which should represent the activation maps of high-level features, and determine the features that most correlate to a particular class. For example, the fully connected layer can determine the high-level features that most strongly correlate to a particular class and can include weights (nodes) for the high-level features. A product can be computed between the weights of the fully connected layer and the pooling hidden layer to obtain probabilities for the different classes. For example, if the CNN is being used to predict that an object is a person, high values will be present in the activation maps that represent high-level features of people (e.g., two legs are present, a face is present at the top of the object, two eyes are present at the top left and top right of the face, a nose is present in the middle of the face, etc.).

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer-executable instructions. These computer-executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-executable instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

Those skilled in the art will recognize improvements and modifications to the preferred embodiments of the present disclosure. All such improvements and modifications are considered within the scope of the concepts disclosed herein and the claims that follow.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. A computer-implemented method for video editing with artificial intelligence algorithms, the computer-implemented method comprising:
accessing, by a computing device comprising artificial intelligence algorithms, metadata associated with one or more media files;
identifying, by the computing device, features in video frames associated with the one or more media files;
identifying, by the computing device, features in audio tracks associated with the one or more media files;
automatically generating, by the computing device, an initial edit of the video frames and the audio tracks based on the metadata, the features in the video frames, and the features in the audio tracks; and
applying, by the computing device, user preferences to the initial edit to generate a final edit.

2. The computer-implemented method of claim 1, wherein the media files comprise one or more of video files or audio files.

3. The computer-implemented method of claim 1, wherein the metadata comprises one or more of timestamps, camera angles, shot descriptions, scene descriptions, lens settings, camera settings, geo-tags, user-defined markers, contextual annotations, or production notes associated with the one or more media files.

4. The computer-implemented method of claim 1, further comprising:
extracting the metadata from the one or more media files;
categorizing the metadata; and
organizing the categorized metadata in a data table.

5. The computer-implemented method of claim 1, wherein the features in the video frames comprise one or more of objects, characters, settings, lighting conditions, colors, visual styles, or motion patterns.

6. The computer-implemented method of claim 1, wherein identifying the features in the video frames associated with the one or more media files comprises:
extracting the video frames from video data associated with the one or more media files;
identifying scene boundaries in the video frames; and
generating suggestions for focal points in the video frames.

7. The computer-implemented method of claim 6, further comprising extracting emotional tones from the video frames based on facial recognition and scene context.

8. The computer-implemented method of claim 1, wherein the features in the audio tracks include one or more of speech, music, ambient sounds, or sound effects.

9. The computer-implemented method of claim 1, wherein identifying the features in the audio tracks associated with the one or more media files comprises:
extracting the audio tracks from audio data associated with the one or more media files;
identifying dialog in the audio tracks; and
converting the dialog to text.

10. The computer-implemented method of claim 9, further comprising:
categorizing a scene based on the text; and
generating subtitles based on the text.

11. The computer-implemented method of claim 1, wherein identifying the features in the audio tracks associated with the one or more media files comprises:
extracting the audio tracks from audio data associated with the one or more media files;
identifying music in the audio tracks;
detecting one or more of tone, rhythm, or dynamics in the music; and
synchronizing the music with the video frames based on the one or more of tone, rhythm, or dynamics in the music.

12. The computer-implemented method of claim 1, wherein the initial edit comprises scene transitions, timing, and sequencing of the video frames based on the metadata, the video frames, and the audio tracks.

13. The computer-implemented method of claim 12, wherein the initial edit further comprises stylistic choices based on user-defined parameters.

14. The computer-implemented method of claim 1, further comprising:
prior to applying the user preferences to the initial edit, transmitting the initial edit to a graphical user interface for display.

15. The computer-implemented method of claim 1, wherein the user preferences comprise templates for pre-designed editorial styles.

16. The computer-implemented method of claim 1, further comprising:
recording the user preferences applied to the initial edit; and
training the artificial intelligence algorithms based on the final edit.

17. The computer-implemented method of claim 1, further comprising:
converting the final edit to a format based on a platform or production type for the final edit; and
exporting the converted final edit.

18. A system for video editing with artificial intelligence algorithms, the system comprising:
at least one memory storing non-transitory computer-executable instructions and at least one artificial intelligence algorithm; and
at least one processor;
wherein, when executed by the at least one processor, the non-transitory computer-executable instructions cause the at least one processor to perform operations comprising:
accessing metadata associated with one or more media files;
identifying, via the at least one artificial intelligence algorithm, features in video frames associated with the one or more media files;
identifying, via the at least one artificial intelligence algorithm, features in audio tracks associated with the one or more media files;
automatically generating, via the at least one artificial intelligence algorithm, an initial edit of the video frames and the audio tracks based on the metadata, the features in the video frames, and the features in the audio tracks; and
applying user preferences to the initial edit to generate a final edit.

19. The system of claim 18, wherein the operations further comprise:
converting the final edit to a format based on a platform or production type for the final edit; and
exporting the converted final edit.

20. A non-transitory computer-readable storage medium having executable instructions stored thereon, wherein the executable instructions, when executed by a processor, are configured to:
access metadata associated with one or more media files;
identify features in video frames associated with the one or more media files;
identify features in audio tracks associated with the one or more media files;
automatically generate an initial edit of the video frames and the audio tracks based on the metadata, the features in the video frames, and the features in the audio tracks; and
apply user preferences to the initial edit to generate a final edit.
